(19) United States
(12) Patent Application Publication
(10) Pub. No.: US 2004/0119801 A1
(43) Pub. Date: Jun. 24, 2004

(54) Ink set for inkjet recording, and inkjet recording method and apparatus using the ink set

(75) Inventors: Atsushi Suzuki, Ebina-shi (JP); Kunichi Yamashita, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/617,716

(22) Filed: Jul. 14, 2003

(30) Foreign Application Priority Data
Dec. 20, 2002 (JP) 2002-370480

(51) Int. Cl. G01D 11/00

(52) U.S. Cl. 347/100

(57) ABSTRACT

The present invention provides an ink set for inkjet recording to form a black image portion in a color image with a black ink and a color ink, wherein the black ink contains at least cationic or anionic self-dispersible carbon black while the color ink contains at least a substance having an opposite polarity to that of the self-dispersible carbon black; and a method and an apparatus for inkjet recording using the ink set.

### CROSS-REFERENCE TO RELATED APPLICATION

This application claims priority under 35 USC 119 from Japanese Patent Application No. 2002-370480, the disclosure of which is incorporated by reference herein.

### BACKGROUND OF THE INVENTION

1. Field of the Invention

The present invention relates to a novel ink set for inkjet recording used for an inkjet recording apparatus (e.g., printers, copiers, facsimiles and word processors), as well as a method and an apparatus for inkjet recording using the ink set.

2. Description of the Related Art

In principle, inkjet recording is carried out by ejecting droplets of a liquid or molten solid ink from a nozzle, a slit or a porous film and the like, to thereby record onto a printing medium such as paper, fabric or film. In order to eject ink, various methods have been proposed such as the so-called static control method, utilizing static attraction, the method utilizing oscillation pressure of a piezoelectric element; and the so-called heat inkjet method, which utilizes pressure that is generated from air bubble formation and growth with heat. By employing these methods, images with a remarkably high level of detail can be created.

Further, inkjet recording apparatuses have been extensively examined since they provide advantages such as being compact, inexpensive and quiet. Recently, inkjet recording apparatuses capable of high-quality printing like a monochrome printer which forms black images and a color printer which provides full-color images have come to be widely sold. These printers can record on regular paper such as writing paper or copier paper, and occupy a major portion of the printing apparatus market.

The ink for inkjet recording used in the inkjet apparatuses must be able to achieve the following:

(1) provide images having high resolution, high density and uniformity, without bleeding or fogging on paper;

(2) cause no clogs at the tip of the nozzle due to dried ink, and exhibiting good ejecting response and good ejecting stability;

(3) be quick-drying on paper;

(4) provide fastness of images; and

(5) possess good long-term storability.

In particular, with the recent rise in printing speeds, there has been a demand for a quick-drying ink capable of providing very high-quality images even when recording is carried out on regular paper such as copier paper. Furthermore, offices use a variety of regular paper, depending on the use area and availability. Specifically when creating a black image, which is most commonly employed, the ink must provide high density and be quick-drying, regardless of the kind of paper being used.

Conventionally, when a penetration-controlling agent such as a surfactant is used to regulate penetration of black ink, it was difficult for the ink to simultaneously exhibit high density and quick-drying since these two characteristics are inherently conflicting. Even if high density and high quality printing can be attained by suppressing the permeation of the black ink, bleeding occurs at portions bordering color ink. In order to solve this problem, a method utilizing a reaction between a black ink and a color ink has been disclosed. Specifically, a method for recording using an ink set consisting of the black ink and the color ink, wherein the black ink contains a cationic substance and a pigment while the color ink contains an anionic dye or a combination of an anionic compound and a pigment is disclosed (see, e.g., Japanese Patent Application Laid-Open (JP-A) No. 9-25442).

Pigments are essentially insoluble in water, but it is nonetheless essential to stably disperse them in the ink. Thus, if a surfactant is used as the dispersant to stably disperse the pigment in the ink, the surface tension decreases more than necessary, which makes problems such as image quality deterioration, or missing prints due to bubbles more likely to occur. If a polymer dispersant is used, viscosity is likely to increase, making it difficult to achieve both good inkjet properties and stable dispersibility. Furthermore, a common problem associated with methods using a dispersant is that interaction between the dispersant and a solvent, or an additive and the like, which are added in order to adjust the characteristics of the ink, may cause dispersibility to fluctuate. For these reasons, the ejecting stability may be easily affected in inkjet recording where ink droplets of 20 pl or less are ejected in order to record finely detailed images.

As a result, methods of using a dispersible pigment without using a dispersant, through treatments such as hydrophilizing treatment, have been researched. A method for hydrophilizing carbon black in the absence of the dispersant and the thus produced ink containing carbon black are disclosed in publications such as WO96/18695.

Further, a method to alleviating bleeding in the boundary regions using an ink set consisting of a black ink and a color ink, wherein the black ink contains a cationic self-dispersible carbon black while the color ink contains an anionic dye and other anionic substances, is disclosed in publications such as JP-A No. 2001-164160.

However, the current situation is that the goals of obtaining both high-density black images and quick-drying ink, regardless of the type of regular paper used, have yet to be achieved.

### SUMMARY OF THE INVENTION

The present invention was made in order to solve the above-mentioned problems and has an object to provide an ink set for inkjet recording that can create high density black images and shorten a drying time when printed on various kinds of regular paper, as well as a method and an apparatus for inkjet recording using the ink set.

The present inventors have conducted intensive research to find that the above-mentioned object can be attained by the invention described below.

A first aspect of the invention is an ink set for inkjet recording for forming a black image portion in a color image with a black ink and a color ink, wherein the black ink comprises at least cationic or anionic self-dispersible carbon black and the color ink comprises at least a substance having an opposite polarity to that of the self-dispersible carbon black.

A second aspect of the invention is a method for inkjet recording which comprises recording a color image in accordance with recording signals by ejecting from an orifice a black ink and a color ink, wherein the black ink comprises at least cationic or anionic self-dispersible carbon black and the color ink comprises at least a substance having an opposite polarity to that of the self-dispersible carbon black, and wherein a black image portion in the color image is formed with the black ink and the color ink, and a time lag between ejecting of the black ink and ejecting of the color ink is 20 ms or less.

A third aspect of the invention is an apparatus for inkjet recording to form a color image which comprises at least an ink cartridge for ejecting a black ink and another ink cartridge for ejecting a color ink, wherein the black ink comprises at least cationic or anionic self-dispersible carbon black and the color ink comprises at least a substance having an opposite polarity to that of the self-dispersible carbon black, and wherein a black image portion in the color image is formed with the black ink and the color ink, and a time lag between ejecting of the black ink and ejecting of the color ink is 20 ms or less.

### DETAILED DESCRIPTION OF THE INVENTION

Hereinafter, the present invention will be explained in further detail.

<Ink Set for Inkjet Recording>

An ink set for inkjet recording according to the invention comprises a black ink and a color ink to form a black image portion in a color image, and the black ink comprises at least cationic or anionic self-dispersible carbon black while the color ink comprises at least a substance having an opposite polarity to that of the self-dispersible carbon black.

To be more precise, in the ink set for inkjet recording according to the invention, if the black ink comprises cationic self-dispersible carbon black, the color ink comprises at least an anionic substance. On the other hand, if the black ink comprises anionic self-dispersible carbon black, the color ink comprises at least a cationic substance.

It is preferable, in the ink set for inkjet recording according to the invention, that the self-dispersible carbon black is cationic and the color ink comprises at least an anionic substance.

First, an embodiment of the ink set for inkjet recording according to the invention, in which the black ink comprises at least cationic self-dispersible carbon black while the color ink comprises at least an anionic substance, will be explained.

(Black Ink)

The self-dispersible carbon black contained in the black ink for use in the present invention refers to a self-dispersible black pigment, which mainly includes carbon black that is dispersible by itself in a solvent in the absence of dispersants such as a surfactant, a polymer dispersant and the like. Usually, the self-dispersible pigment has a hydrophilic functional group at the surface thereof, and hence, a cationic self-dispersible carbon black has a cationic hydrophilic functional group.

In the present invention, determining whether the pigment is self-dispersible or not is confirmed by the following self-dispersibility test.

[Test for Determining Self-Dispersibility]

A test pigment is added to and dispersed in water in the absence of a dispersant, using an ultrasonic homogenizer, a nanomizer, a microfluidizer, a ball mill or the like, followed by diluting with water to bring a initial pigment concentration to about 5%. Furthermore, 100 g of the resultant dispersion is charged into a glass bottle having a diameter of 40 mm and maintained standing for 1 day, and the concentration of the pigment in a supernatant is determined. When a ratio of the pigment concentration determined after 1 day standing, relative to the initial pigment concentration, (hereinafter referred to as “self-dispersibility index”) is 98% or higher, it is rated as “self-dispersible”.

During this evaluation, the method for determining the concentration of the pigment is not specifically limited to methods, such as those comprising drying the sample and measuring a solids content thereof, diluting the sample to an appropriate concentration and measuring the concentration from the transmittance of the sample. If other methods for precisely determining the concentration of the pigment are available, such methods may be used as well.

The self-dispersible carbon black is obtained by introducing hydrophilic functional groups into carbon black.

The carbon black to which the hydrophilic functional groups are introduced includes carbon blacks such as furnace black, lamp black, acetylene black, channel black and the like. Specific examples include, but are not limited to, Raven 7000, Raven 5750, Raven 5250, Raven 5000 ULTRA II, Raven 3500, Raven 2500 ULTRA, Raven 2000, Raven 1500, Raven 1255, Raven 1250, Raven 1200, Raven 1190 ULTRA II, Raven 1170, Raven 1080 ULTRA, Raven 1060 ULTRA, Raven 790 ULTRA, Raven 780 ULTRA, Raven 760 ULTRA (all of these manufactured by Colombian Carbon Company); Rega 1400R, Rega 1330R, Rega 1660R, Mogul L, Monarch 700, Monarch 800, Monarch 880, Monarch 900, Monarch 1000, Monarch 1100, Monarch 1300, Monarch 1400 (all of these manufactured by Cabot Corporation); Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A, Special Black 4 (all of these manufactured by Degussa AG); No. 25, No. 33, No. 40, No. 47, No. 52, No. 900, No. 2300, MCF-88, MA600, MA7, MA8, MA100 (all of these manufactured by Mitsubishi Chemical Co., Ltd.), and the like. An additional carbon black, which is newly synthesized, may also be used.

In order to introduce cationic hydrophilic functional groups into the above-mentioned carbon black, a conventionally known method may be used. For example, a known method of treating carbon black with a diazonium salt compound having a cationic group may be used, and furthermore a newly developed method may also be used.

As the substance which forms a salt with the cationic group, a variety of acidic substances may be used. Preferably, nitric acid, hydrochloric acid, phosphoric acid, acetic acid and the like may be used singly or in combination thereof.

The self-dispersible carbon black is contained in an amount of preferably 0.1 to 20% by mass, more preferably 1 to 10% by mass, and still more preferably 3 to 7% by mass, relative to a total amount of the black ink. When the addition amount of the self-dispersible carbon black is more than 20% by mass, clogging caused by water evaporation at the tip of the nozzle may be worsened. On the other hand, when the amount of the self-dispersible carbon black is less than 0.1 parts by mass, a sufficient concentration may not be obtained.

The self-dispersible carbon black is preferably purified by removing impurities, for example, contaminants such as remaining oxidants, other inorganic contaminants, organic contaminants, and the like. Specifically, it is preferable to reduce the content each of calcium, iron, silicon in the black ink is below 10 ppm, and more preferably below 5 ppm. The content of the inorganic contaminant can be measured by, for example, an inductively coupled plasma emission spectrometer or the like.

The impurities can be removed by methods such as washing with water, reverse osmosis membrane, ultrafiltration membrane, ion exchanging method and the like, adsorption method using active carbon, zeolite and the like, decomposition method by heating, and the like. These methods may be carried out singly or in combination thereof.

Examples of the water-soluble organic solvent, contained in the black ink for the ink set for inkjet recording according to the invention, include polyvalent alcohols such as ethylene glycol, diethylene glycol, propylene glycol, dipropylene glycol, butylene glycol, triethylene glycol, 1,5-pentanediol, 1,2,6-hexanetriol, trimethylol propane, glycerine, polyethylene glycol and the like; lower alcohols such as ethanol, isopropylalcohol, 1-propanol and the like; nitrogen-containing solvents such as pyrrolidone, N-methyl-2-pyrrolidone, cyclohexylpyrrolidone, triethanolamine and the like; sulfur-containing solvents such as thiodiethanol, thiodiglycerol, sulfolane, dimethylsulfoxide and the like; sugars such as glucose, fructose, galactose, mannose, xylose and the like, derivatives thereof and sugar alcohols; oxyethylene adduct of glycerine; oxyethylene adduct of diglycerine; propylene carbonate, ethylene carbonate, and the like.

These water-soluble organic solvents may be used alone or in admixture thereof. The water-soluble organic solvent is contained in an amount of preferably 1 to 60% by mass, and more preferably 5 to 40% by mass relative to the black ink.

Specifically, for use as the water included in the black ink for the ink set for inkjet recording according to the invention, ion exchanged water, ultrapure water, distilled water or ultrafiltered water is preferable in order to prevent contamination.

The black ink for the ink set for inkjet recording according to the invention may optionally include a surfactant for the purpose of adjusting permeability and the like. The usable surfactant may be selected from various nonionic surfactants, cationic surfactants, amphoteric surfactants and the like, among which nonionic surfactants are preferably used.

Examples of the nonionic surfactant include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerine fatty acid ester, polyoxyethylene glycerin fatty acid ester, polyglycerine fatty acid ester, sucrose fatty acid ester, polyoxyethylene alkylamine, polyoxyethylene fatty acid amide, alkylalkanol amide, polyethylene glycol/polypropylene glycol block copolymer, acetylene glycol, polyoxyethylene adduct of acetylene glycol, and the like. Specifically, polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylolamide, polyethylene glycol/polypropylene glycol block copolymer, acetylene glycol, polyoxyethylene adduct of acetylene glycol are preferable.

Besides, silicone-based surfactants such as polysiloxane oxyethylene adduct; fluorine-based surfactants such as perfluoroalkyl carbonates, perfluoroalkyl sulfonates, or oxyethyleneperfluoroalkyl ether; biosurfactants such as spiculisporic acid, rhamnolipid or lysolecithin; and the like can be used.

Among the above-mentioned surfactants, surfactants having an unsaturated bond and surfactants having a secondary or tertiary alkyl group are more preferably used.

Examples of the surfactant having an unsaturated bond include alkyl ether derivatives of an unsaturated alcohol such as oleyl alcohol, elaidyl alcohol, linoleyl alcohol, linolenyl alcohol, 2-heptadecen-1-ol, acetylene alcohol and the like, alkyl ester derivatives of an unsaturated fatty acid such as lauroleinic acid, myristoleinic acid, oleic acid, linoleic acid, linolenic acid, dodecenoic acid, octadecynoic acid and the like.

Examples of the surfactant having a secondary or tertiary alkyl group include alkyl ether derivatives of branched alcohols such as 2ethylhexyl alcohol, 2-octanol, 2-hexadecanol, 2-octadecanol and the like, alkyl esters of branched fatty acids such as methylheptadecanoic acid, methylpentadecanoic acid, methyloctadecanoic acid and the like.

These surfactants may be used alone or in admixture thereof. The surfactant preferably has an HLB in the range of 3 to 20 from the standpoints of solution stability and the like.

The addition amount of the surfactant is preferably 0.001 to 5% by mass, and particularly preferably 0.01 to 3% by mass, relative to the amount of the black ink and the amount of the color ink, respectively.

The surfactant may be copolymerized with a monomer such as stylene derivatives such as stylene, α-methylstyrene, vinyltoluene and the like, monomers such as vinylnaphthalene, vinylnaphthalene derivatives, acrylic acid alkyl esters, methacrylic acid alkyl esters, crotonic acid alkyl esters, itaconic acid dialkyl esters, maleic acid dialkyl esters and the like, monomers having a sulfonic acid group, hydroxy group, polyoxyethylene or the like, for the purpose of adjusting polymer characteristics.

The black ink according to the invention may include a polymer such as polyvinyl alcohol, polyvinyl pyrrolidone, polyacrylamide, poly N-vinylacetamide and the like.

When the polymer is a water-soluble polymer, a weight-average molecular weight of the polymer is preferably in the range of 1,000 to 30,000, and more preferably in the range of 3,000 to 15,000.

When the polymer is a water-dispersible polymer, an average particle size is preferably 0.5 μm or less, more preferably in the range of 0.1 to 0.3 μm.

Further, the polymer preferably has film-forming properties insofar as it does not adversely affect printing ability. The lowest temperature for film formation is, if the printed article is not heated after printing, preferably 20° C. or less, and more preferably 10° C. or less. On the other hand, when the printed article is heated after printing, the lowest temperature for film formation is preferably lower than the temperature to which the printed article reaches.

The black ink contained in the ink set for inkjet recording according to the invention may include as a penetrant a compound represented by the following formula (1):

R—O—XnH (1)

wherein R is a functional group having 4 to 8 carbon atoms selected from the group consisting of an alkyl group, an alkenyl group, an alkynyl group, a phenyl group, an alkylphenyl group, an alkenylphenyl group and a cycloalkyl group; X is an oxyethylene group or an oxypropylene group; and n is an integer from 1 to 4.

Examples of the compound represented by the above formula (1) include ethyleneglycol monobutyl ether, diethyleneglycol monobutyl ether, propyleneglycol monobutyl ether, diethyleneglycol monohexyl ether, dipropyleneglycol monobutyl ether, triethyleneglycol monobutyl ether, triethyleneglycol monohexyl ether, diethyleneglycol monocyclohexyl ether, triethyleneglycol monophenylethyl ether, dioxypropylene oxyethylene monopentyl ether and the like. Among these, diethyleneglycol monobutyl ether is preferred.

The compound represented by the above formula (1) is contained in an amount preferably in the range of 1 to 20% by mass, and more preferably 1 to 10% by mass relative to a total amount of the ink inclusive of the black ink and the color ink. When the addition amount of the compound represented by the above formula (1) is more than 20% by mass, bleeding is aggravated and ejecting of the ink may become unstable. On the other hand, when the amount of the compound represented by the above formula (1) is less than 1% by mass, the effect of adding the compound may be lowered.

The black ink according to the invention may optionally include a pH controlling agent for the purpose of adjusting the pH of the ink. Examples of the pH controlling agent include acids such as hydrochloric acid, sulfuric acid, nitric acid, acetic acid, citric acid, oxalic acid, malonic acid, boric acid, phosphoric acid, phosphorous acid, lactic acid and the like, bases such as potassium hydroxide, sodium hydroxide, lithium hydroxide, ammonium hydroxide, triethanolamine, diethanolamine, ethanolamine, 2-amino-2-methyl-1-propanol, ammonia and the like, pH buffers such as phosphate, oxalate, aminate, Good's buffer and the like.

Other additives are optionally contained in the black ink for use in the invention. Specifically, as the additives for controlling ink characteristics, cellulose derivatives such as ethyl cellulose, carboxymethyl cellulose and the like, polysaccharides and derivatives thereof, polyethylene glycol, cyclodextrin, macrocyclic amines, dendrimers, crown ethers and the like may be used. Furthermore, known fungicides such as benzoic acid, 1,2-benzisothiazolin-3-one, dehydroacetic acid and the like, antiseptics, antioxidants, viscosity controlling agents, electrically conductive agents, UV absorbents, chelating agents and the like can optionally be added to the black ink.

The volume average particle size of the dispersed particles in the black ink according to the invention is preferably in the range of 30 to 120 nm, and more preferably 40 to 110 nm. If the volume average particle size is less than 30 nm, the density of the image created on a regular paper may be lowered, and a difference in density may significantly increase depending on the kinds of paper used. On the other hand, if the volume average particle size is more than 120 nm, the storability of the ink may be reduced.

In the invention, the particle size of the dispersed particles is defined as a value measured using a microtrack UPA particle size analyzer 9340 (manufactured by Leeds & Northrup), without diluting the black ink. As the parameters to be inputted during the measurement, the viscosity of the ink to be tested and the concentration of the dispersed particles of 1.8 are adopted.

In the invention, among the dispersed particles present in the black ink, the volume ratio of the particles having a particle size of 0.5 to 1.0 μm relative to the black ink is preferably in the range of 0.001 to 0.03%, more preferably 0.005 to 0.02%, and more preferably 0.007 to 0.02%. If the volume ratio is less than 0.001%, the image density may be reduced. On the other hand, if the volume ratio is more than 0.03%, the liability of printing after left standing for a long period of time may occasionally be lowered.

In the invention, the volume ratio of the particles having the particle size of 0.5 to 1.0 μm is determined using Accusizer™ 770 Optical Particle Sizer (manufactured by Particle Sizing Systems, Inc.) as a measuring instrument. The particles passing the measurement unit can be detected using this instrument through optical techniques.

The volume of the particles having the particle size of 0.5 to 1.0 μm is determined by loading a water-soluble inkjet recording liquid (2 μl) in a measurement cell, employing a predetermined procedure and converting the obtained values to a desired unit. Adjustment of the volume of the particles of 0.5 to 1.0 μm among the dispersed particles present in the black ink to a desired range of volume can be carried out by centrifuging and filtering the pigment dispersion used for the black ink or the black ink itself, or admixing of dispersed particles other than the pigments.

In the ink for inkjet recording according to the invention, the self-dispersible carbon black in the black ink has a zeta potential preferably in the range of +5 to +35 mV. If the value of the zeta potential is less than +5 mV, the long-term storability of the recording liquid may be deteriorated. The value of the zeta potential of the self-dispersible carbon black in the black ink varies depending on the ionic functional groups at the surface of the dispersed pigment, the content of the electrolyte in the ink, pH, and the like. Therefore, the value of the zeta potential is different from that measured in a diluted ink or in a dispersion medium other than the black ink.

Hereinafter, the principle of the zeta potential will be explained. Usually in a system in which solids are dispersed in a liquid, if free electric charges exist on the surface of a solid phase, a charged layer having the opposite electric charge appears in a liquid phase near the solid boundary so as to keep the electric neutrality. This is called an electric double layer, and the potential difference due to the electric double layer is called a zeta potential. Several methods for measuring the zeta potential have been known, such as measurement via electrophoresis, electrokinetic sonic amplitude method (ESA method), ultrasonic vibration potential method (UPA method) and the like. In the invention, the zeta potential is measured by ESA method, using a concentrated solution such as an aqueous inkjet recording liquid without diluting the solution. The principle of the measurement by the ESA method is as follows. When an alternating electric field is applied to a dispersion, the dispersed substance undergoes electrophoresis due to the alternating electric field. By measuring the pressure generated by the electrophoresis using a piezoelectric element, the zeta potential can be obtained according to the following equation (2).

Formula (2)

Zeta potential=ESA·η·G(α)⁻¹/ε·c·Δρ·V

In the equation (2), ESA is a value obtained by the measurement, which represents a pressure per unit electric field. η is a viscosity of the solvent, G(α)⁻¹ is a correction term for the action by inertia force, ε is a dielectric constant of the solvent, c is a sonic velocity in the solvent, Δρ is a difference in concentration between the solvent and the particles, and V is a volume fraction of the particles.

As a result of investigating each of the above-mentioned parameters, it is found that η can be used as the viscosity of the ink, ε as the dielectric constant of water, Δρ as the difference in concentration between the coloring material and water, and V as the volume fraction of the coloring material. Therefore, in the invention, measurement of the zeta potential is carried out using these parameters. Using ESA-8000 (manufactured by Matec Applied Science Corporation), the measurement is carried out through a prescribed procedure by charging an inkjet recording liquid (50 ml) in a 100 ml beaker and immersing a measuring probe into a predetermined depth.

(Color Ink)

Examples of the anionic substance contained in the color ink according to the invention include an anionic dye, an anionic self-dispersible dye, an anionic polymer and an anionic surfactant. That is, the color ink according to the invention may include any one of the above-mentioned anionic substances singly or in combination thereof.

As the colorant contained in the color ink according to the invention, either a dye or a pigment may be used. The dyes capable of developing superior color are preferably used. Among the dyes, a water-soluble dye is preferred. Any of an acidic dye, a direct dye, a basic dye and a reactive dye may be used as the water-soluble dye, with the acidic dye and the direct dye being preferable.

Examples of the anionic dye include, but are not limited to, the following:

C. I. Direct Blue-1, -2, -6, -8, -22, -34, -70, -71, -76, -78, -86, -112, -142, -165, -199, -200, -201, -202, -203, -207, -218, -236, and -287;

C. I. Direct Red-1, -2, -4, -8, -9, -11, -13, -15, -20, -28, -31, -33, -37, -39, -51, -59, -62, -63, -73, -75, -80, -81, -83, -87, -90, -94, -95, -99, -101, -110, -189, and -227;

C. I. Direct Yellow-1, -2, -4, -8, -11, -12, -26, -27, -28, -33, -34, -41, -44, -48, -58, -86, -87, -88, -135, -142, and -144;

C. I. Acid Blue-1, -7, -9, -15, -22, -23, -27, -29, -40, -43, -55, -59, -62, -78, -80, -81, -83, -90, -102, -104, -111, -185, -249, and -254;

C. I. Acid Red-1, -4, -8, -13, -14, -15, -18, -21, -26, -35, -37, -52, -110, -144, -180, -249, and -257;

C. I. Acid Yellow-1, -3, -4, -7, -11, -12, -13, -14, -18, -19, -23, -25, -34, -38, -41, -42, -44, -53, -55, -61, -71, -76, -78, -79, and -122; and the like.

The amount of the anionic dye contained in the color ink for use in the invention is preferably in the range of 0.1 to 20% by mass, more preferably in the range of 1 to 10% by mass, and still more preferably in the range of 1 to 5% by mass relative to a total amount of the ink inclusive of the black ink. When the addition amount of the anionic dye is more than 20% by mass, clogging caused by water evaporation at the tip of the nozzle may be worsened. On the other hand, when the amount of the anionic dye is less than 0.1% by mass, a sufficient density may not be obtained.

The anionic self-dispersible pigments are listed below.

Examples of the cyan pigment include, but are not limited to, C. I. Pigment Blue 1, C. I. Pigment Blue 2, C. I. Pigment Blue 3, C. I. Pigment Blue 15, C. I. Pigment Blue 15:1, C. I. Pigment Blue 15:3, C. I. Pigment Blue 15:4, C. I. Pigment Blue 16, C. I. Pigment Blue 22, C. I. Pigment Blue 60 and the like.

Examples of the magenta pigment include, but are not limited to, C. I. Pigment Red 5, C. I. Pigment Red 7, C. I. Pigment Red 12, C. I. Pigment Red 48, C. I. Pigment Red 48:1, C. I. Pigment Red 57, C. I. Pigment Red 112, C. I. Pigment Red 122, C. I. Pigment Red 123, C. I. Pigment Red 146, C. I. Pigment Red 168, C. I. Pigment Red 184, C. I. Pigment Red 202, C. I. Pigment Violet 1960 and the like.

Examples of the yellow pigment include, but are not limited to, C. I. Pigment Yellow 1, C. I. Pigment Yellow 2, C. I. Pigment Yellow 3, C. I. Pigment Yellow 12, C. I. Pigment Yellow 13, C. I. Pigment Yellow 14, C. I. Pigment Yellow 16, C. I. Pigment Yellow 17, C. I. Pigment Yellow 55, C. I. Pigment Yellow 73, C. I. Pigment Yellow 74, C. I. Pigment Yellow 75, C. I. Pigment Yellow 83, C. I. Pigment Yellow 93, C. I. Pigment Yellow 95, C. I. Pigment Yellow 97, C. I. Pigment Yellow 98, C. I. Pigment Yellow 114, C. I. Pigment Yellow 128, C. I. Pigment Yellow 129, C. I. Pigment Yellow 150, C. I. Pigment Yellow 151, C. I. Pigment Yellow 154, C. I. Pigment Yellow 180, C. I. Pigment Yellow 185 and the like.

Besides the dyes of three primary colors of cyan, magenta and yellow, the pigments of predetermined colors such as red, green, blue, brown, white or the like, metallic gloss pigments such as gold, silver or the like, colorless extender pigments, plastic pigments and the like may be used. Further, a pigment which is newly synthesized for use in the invention may also be used. These color pigments can be used by undergoing dispersing operation with the aid of a known dispersant, or subjected to self-dispersing treatment using the method as mentioned for the self-dispersible carbon black. Self-dispersible color pigments are preferred.

As the anionic polymer, polymers obtained by effecting polymerization, known water-soluble resins such as naturally occurring resins, polymer emulsions and the like can be used. The anionic polymer preferably has a hydrophilic group so that the polymer can be dissolved or dispersed in water, and the hydrophilic group is preferably a carboxyl group, a sulfone group, or a salt thereof. As the anionic polymer, a polymer obtained by polymerizing a monomer having a carboxyl group, or a salt thereof is preferably used.

Examples of the monomer having a carboxyl group include acrylic acid, methacrylic acid, maleic acid, crotonic acid, itaconic acid, itaconic acid monoester, maleic acid, maleic acid monoester, fumaric acid, fumaric acid monoester and the like.

In order to adjust the polymer characteristics such as an acid value, monomers such as styrene derivatives such as styrene, α-methylstyrene, vinyltoluene and the like, vinylnaphthalene, vinylnaphthalene derivatives, acrylic acid alkyl esters, methacrylic acid alkyl esters, crotonic acid alkyl esters, itaconic acid dialkyl esters, maleic acid dialkyl esters and the like, or monomers having a sulfonic acid group, hydroxyl group, polyoxyethylene and the like may be copolymerized, besides the anionic monomers having a hydrophilic group.

The polymer having an acidic group is preferably neutralized for use as a neutralized salt. Neutralization is carried out using various basic substances, and preferably is neutralized with a basic substance containing an alkaline metal hydroxide. Examples of the alkaline metal hydroxide include NaOH, KOH, LiOH, with NaOH being preferred.

Examples of the anionic surfactant include alkyl benzene sulfonate, alkyl phenyl sulfonate, alkyl naphthalene sulfonate, higher fatty acid salt, sulfuric ester salt of higher fatty acid ester, sulfonate of higher fatty acid ester, sulfuric ester salt and sulfonate of higher alcohol ether, higher alkyl sulfosuccinate, polyoxyethylene alkyl ether carboxylate, polyoxyethylene alkyl ether sulfate, alkyl phosphate, polyoxyethylene alkyl ether phosphate and the like. Specifically, dodecylbenzenesulfonate, isopropylnaphthalenesulfonate, monobutylphenylphenol monosulfonate, monobutylbiphenyl sulfonate, monobutylbiphenyl sulfonate, dibutylphenylphenol disulfonate and the like are preferred.

The color ink according to the invention may also include a nonionic surfactant. Examples of the nonionic surfactant include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, sucrose fatty acid ester, polyoxyethylene alkylamine, polyoxyethylene fatty acid amide, alkylalkanolamide, polyethylene glycol/polypropylene glycol block copolymer, acetylene glycol, polyoxyethylene adduct of acetyleneglycol and the like. Specifically, polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylolamide, polyethylene glycol/polypropylene glycol block copolymer, acetylene glycol, polyoxyethylene adduct of acetyleneglycol and the like are preferred.

The water-soluble organic solvent contained in the color ink may be the same as or different from the solvent contained in the black ink. The other ingredients used in the color ink may be the same as or different from those used in the black ink.

The surface tension of each ink of the ink set for inkjet recording according to the invention is preferably in the range of 25 to 50 mN/m. In more detail, the black ink has a surface tension more preferably in the range of 30 to 50 mN/m, and still more preferably in the range of 30 to 40 mN/m. On the other hand, the color ink has a surface tension more preferably in the range of 25 to 40 mN/m, and still more preferably in the range of 28 to 37 mN/m. If the surface tension is more than 50 mN/m, the period for the ink to dry may be prolonged. On the other hand, if the surface tension is less than 25 mN/m, the optical density of the obtained image on printing paper may be decreased or the image quality may be reduced.

The viscosity of each ink in the ink set for inkjet recording according to the invention is preferably in the range of 1.5 to 5.0 mPa·s, and more preferably in the range of 1.8 to 3.0 mPa·s. If the viscosity is less than 1.5 mPa·s, the ink storability may decrease. On the other hand, if the viscosity is more than 5.0 mPa·s, the ejecting power may decrease and recovery from the clogging incidence may become difficult.

While the electrical conductivity of the ink set for ink-jet recording according to the invention varies depending on the substances added to the ink and cannot generally be specified, it is preferably in the range of 0.05 to 0.4 S/m, and more preferably in the range of 0.07 to 0.3 S/m. When the electrical conductivity is over the range of 0.05 to 0.4 S/m, the ink storability may easily be reduced.

The pH of each ink in the ink set for inkjet recording according to the invention is preferably in the range of 6.0 to 11.0, and more preferably 7.5 to 9.0. When the pH is less than 6.0, clogging and a decrease in storability may easily occur. On the other hand, when the pH is more than 11.0, the elements for forming the head are likely to erode or dissolve.

Each ink for the ink set for inkjet recording according to the invention can be prepared by, for example, dispersing a self-dispersible carbon black in water to prepare a water dispersion and optionally removing coarse particles via centrifugation or the like. The dispersion of the self-dispersible carbon black may be further dispersed by conventionally known dispersing means. Alternatively, the dispersing treatment may be performed in combination with centrifuging treatment. To the thus obtained pigment dispersion is added a predetermined solvent, surfactant, other additives and the like, and stirring is provided followed by filtration, to thereby to give an ink.

<Method for Inkjet Recording>

The method for inkjet recording according to the invention is an inkjet recording method which comprises recording for forming color images by ejecting, from an orifice in accordance with recording signals, a black ink and a color ink, wherein the black ink is the above-mentioned black ink according to the invention and the color ink is the above-mentioned color ink according to the invention.

In the method for inkjet recording according to the invention, the above-mentioned self-dispersible carbon black is preferably cationic, while the above-mentioned color ink preferably contains at least an anionic substance.

Furthermore, the method for inkjet recording according to the invention is characterized by that the black image portion in the color image contains the black ink and the color ink, and a time lag between ejecting of the black ink and ejecting of the color ink is 20 ms or less.

The time lag between ejecting of the black ink and ejecting of the color ink is determined by a distance between the ejecting head for black ink and another ejecting head for color ink, which is located at the position nearest to the ejecting head for black ink, and a scanning velocity. By recording with a time lag of 20 ms or less, even when the order of recording the color ink and the black ink is inverse during reciprocal scanning movement, both inks are effectively mixed to react with each other on paper before penetration, whereby high density of images can be obtained.

The time lag between ejecting two inks is preferably 16 ms or less, and more preferably 10 ms or less.

In the method for inkjet recording according to the invention, a composition of the ink and an ejecting amount of the ink on paper are preferably adjusted such that a drying time of the ink ejected and placed on regular paper becomes 5 s or less.

As used herein, the drying time refers to a time period from a time point of printing the ink to another time point when none of the images printed on paper are transferred to the back face of the paper even when paper sheets are stacked. If the drying time exceeds 5 s, it poses problems in that irregular bleeding or intercolor bleeding easily takes place, and when a paper sheet is stacked on another sheet having an image, the ink may be transferred to the back face of the paper sheet stacked.

In the method for inkjet recording according to the invention, it is preferred that the drying time of the color ink is shorter than that of the black ink. The drying time can be adjusted by controlling ink characteristics such as surface tension, viscosity or the like of the ink, by adding a penetrant such as a surfactant and a polymer, or by adjusting the amount of ink droplets expelled during printing, printing density and the like. Such controlling means may be employed singly or in combination. If the drying time of the color ink is longer than that of the black ink, intercolor bleeding may easily occur on the recording medium.

In the method for inkjet recording according to the invention, it is preferable that the amount of one droplet of the black ink expelled is 20 ng or less, and the amount of one droplet of the color ink expelled is 7 ng or less. When images are recorded employing these amounts of the inks, the ink for inkjet recording according to the invention can provide an image having high density and high quality, without impairing dryness of the ink. When the amount of the ink is too large, the drying time of the ink may be prolonged and the image quality may also be reduced.

Further, in the method for inkjet recording according to the invention, the printed amount of the color ink to form the black image portion is preferably specified in a range of 10 to 50% relative to the amount of the black ink. The use amount of the color ink may vary depending on the proportion each of the cyan, magenta and yellow dyes, or may be adjusted to alter the color tone at the black image portion.

<Apparatus for Inkjet Recording>

The apparatus for inkjet recording according to the invention is an inkjet recording apparatus for recording to form color images. This apparatus comprises at least an ink cartridge for ejecting a black ink and another ink cartridge for ejecting a color ink, and the black ink to be ejected is the above-mentioned black ink and the color ink to be ejected is the above-mentioned color ink, contained in the ink set for inkjet recording according to the invention.

For use in the inkjet recording apparatus according to the invention, the self-dispersible carbon black is preferably cationic and the color ink preferably contains at least an anionic substance.

Furthermore, the inkjet recording apparatus according to the invention has a characteristic feature in that it provide the color images in which the black image portion is formed with the black ink and the color ink, and the time lag between ejecting the black ink and ejecting the color ink is 20 ms or less.

The time lag between ejecting the black ink and ejecting the color ink is determined by a distance between the ejecting head for black ink and another head ejecting head for color ink, which is located at the nearest position to the ejecting head for black ink, and a scanning velocity. By recording with a time lag of 20 ms or less, even when the order of recording the color ink and the black ink is inverted during a back-and forth scanning movement, both inks are effectively mixed to react with each other on paper before penetration, to thereby obtain high density images.

The time lag between ejecting two inks is preferably 16 ms or less, and more preferably 10 ms or less.

The ink cartridge for ejecting color ink may comprise separate color ink cartridges or it may have three color inks in the same cartridge. The time lag between ejecting of the black ink and ejecting of the color ink is determined by a distance between the ejecting head for black ink and another ejecting head for color ink, which is located at the nearest position to the ejecting head for black ink, and a scanning velocity. By recording with a time lag of 20 ms or less, even when the order of printing the color ink and the black ink is inverted during reciprocal scanning movement, both inks are effectively mixed to react with each other on paper before penetration, to thereby create high density images.

The ink set for inkjet recording according to the invention can be used in a conventional thermal inkjet recording apparatus as a matter of course, and in a recording apparatus equipped with a heater to assist fixation of the ink on paper, a recording apparatus equipped with an intermediate transfer system, which sprays droplets of the ink on an intermediate and then transfers the ink onto a printing medium such as paper, and the like.

A preferred embodiment of the ink set for inkjet recording according to the invention, in which the black ink comprises at least cationic self-dispersible carbon black while the color ink comprises at least an anionic substance, is detailed as above. However, the ink set for inkjet recording according to the invention can also exert similar effects, by employing another embodiment in which the black ink comprises at least anionic self-dispersible carbon black while the color ink comprises at least a cationic substance.

### EXAMPLES

The present invention will now be described in more detail with referring to the following Examples.

(Preparation of a Black Ink)

Preparation of Black Ink 1

The following ingredients are mixed and thoroughly stirred, and the resultant mixture is filtered using a membrane filter having a pore size of 2 μm to thereby prepare Black ink 1. The zeta potential of this black ink is +8 mV.

| | | |
|---|---|---|
| Cationic self-dispersible carbon black | 33.33 | parts by mass |
| (manufactured by Cabot Inc.; | | |
| solid content: 15%) | | |
| Diethylene glycol | 20 | parts by mass |
| Polyoxyethylene adduct | 0.15 | parts by mass |
| of 2-ethylhexylalcohol | | |
| Polyoxyethylene oleyl ether | 0.07 | parts by mass |
| Water | 46.45 | parts by mass |

Preparation of Black Ink 2

The following ingredients are mixed and thoroughly stirred, and the obtained mixture is filtered using a membrane filter having a pore size of 2 μm to thereby give Black ink 2. The zeta potential of this black ink is −32 mV.

| | | |
|---|---|---|
| CABOJET300 (Cationic self-dispersible | 33.33 | parts by mass |
| carbon black, manufactured by Cabot Inc.; | | |
| solid content: 15%) | | |
| Diethylene glycol | 20 | parts by mass |
| Polyoxyethylene adduct | 0.15 | parts by mass |
| of 2-ethylhexylalcohol | | |
| Polyoxyethylene oleyl ether | 0.07 | parts by mass |
| Water | 46.45 | parts by mass |

(Preparation of a Color Ink)

Preparation of Cyan Ink 1 (anionic)

The following ingredients are mixed and thoroughly stirred. The pH of the resulting mixture is adjusted to 8 with a 1N aqueous NaOH solution, followed by filtration using a membrane filter having a pore size of 0.45 μm to thereby yield an ink.

| | | |
|---|---|---|
| C.I. Direct Blue 199 | 3 | parts by mass |
| Diethylene glycol | 20 | parts by mass |
| Diethylene glycol monobutyl ether | 5 | parts by mass |
| Urea | 6 | parts by mass |
| Water | 66 | parts by mass |

Preparation of Magenta Ink 1 (anionic) Magenta ink 1 is prepared in a similar manner to that of Cyan ink 1, except that C. I. Acid Red 52 is used instead of C. I. Direct Blue 199.

Preparation of Yellow Ink 1 (anionic)

Yellow ink 1 is prepared in a similar manner to that of Cyan ink 1, except that C. I. Direct Yellow 144 is used instead of C. I. Direct Blue 199.

(Evaluation for Characteristics of Ink)

These inks are evaluated for the following characteristics. The results are shown in the following Table 1.

(Surface Tension of Ink)

In an atmosphere of 23° C. and 55% RH, each ink is measured for a surface tension using a Wilhelmy's surface tension measuring device.

(Viscosity of Ink)

Each ink is assessed for a viscosity using Reomat RM260 (manufactured by Mettler-Toledo International, Inc.), by charging the test ink in a measurement vessel and fitting the vessel in the apparatus in accordance with the instructions thereof. The measurement is conducted under the conditions of 23° C. and the shear rate of 1400 s⁻¹.

(Particle Size of Ink)

The particle size of the ink is obtained by measuring the number average particle size, without diluting the ink, using a microtrack UPA particle size analyzer 9340 (manufactured by Leeds & Northrup). As the parameters to be inputted during the measurement, a viscosity of the test ink is adopted as the viscosity and a concentration of the coloring material is adopted as the concentration of the dispersed particles.

TABLE 1

| | | Viscosity | Particle |
|---|---|---|---|
| | Surface Tension of | of Ink | Size of Ink |
| | Ink (mN/m) | (mPa · s) | (nm) |
| Black ink 1 | 37 | 2.5 | 40 |
| Black ink 2 | 36 | 2.4 | 55 |
| Cyan ink 1 | 38 | 2.4 | — |
| Magenta ink 1 | 38 | 2.6 | — |
| Yellow ink 1 | 39 | 2.5 | — |

### Example 1

The obtained Black ink 1, Cyan ink 1, Magenta ink 1 and Yellow ink 1 are filled in a pre-manufactured thermal inkjet printing head (an ejecting amount of one droplet of Black ink 1 is 15 ng, an ejecting amount of one droplet of each Cyan ink 1, Magenta ink 1 and Yellow ink 1 is 5 ng, the four colors can be printed at one location by one scanning using four separate heads for respective colors, and the time lag between ejecting the black ink and ejecting the most nearest color ink is 16 ms). Recording is carried out with a proportion of 100% of Black ink 1 and each 30% of Cyan ink 1, Magenta ink 1 and Yellow ink 1, with reciprocal movement of the head in two divisions, to thereby create a black image. The paper used are FX-P Paper (manufactured by Fuji Xerox Co, Ltd.), and 4024 Paper and 4200 Paper (manufactured by Xerox Corporation).

### Comparative Example 1

The obtained Black ink 1 is filled in a pre-manufactured thermal inkjet printing head (an ejecting amount of one droplet of Black ink 1 is 15 ng). Recording is carried out using a Black ink 1, with reciprocal movement of the head in two divisions, to thereby form a black image. The paper used are FX-P Paper (manufactured by Fuji Xerox Co, Ltd.), and 4024 Paper and 4200 Paper (manufactured by Xerox Corporation).

### Comparative Example 2

The obtained Black ink 2, Cyan ink 1, Magenta ink 1 and Yellow ink 1 are filled in a pre-manufactured thermal inkjet recording head (an ejecting amount of one droplet of Black ink 1 is 15 ng, an ejecting amount of one droplet of each Cyan ink 1, Magenta ink 1 and Yellow ink 1 is 5 ng, the four colors can be printed at one location by one scanning using four separate heads for respective colors, and the time lag ejecting between the black ink and ejecting the nearest color ink is 16 ms). Recording is carried out with a proportion of 100% of Black ink 2 and each 30% of Cyan ink 1, Magenta ink 1 and Yellow ink 1, with reciprocal movement of the head in two divisions, to thereby create a black image. The paper used are FX-P Paper (manufactured by Fuji Xerox Co, Ltd.), and 4024 Paper and 4200 Paper (manufactured by Xerox Corporation).

### Comparative Example 3

The obtained Black ink 1, Cyan ink 1, Magenta ink 1 and Yellow ink 1 are filled in a pre-manufactured thermal inkjet printing head (an ejecting amount of one droplet of Black ink 1 is 15 ng, an ejecting amount of one droplet of each Cyan ink 1, Magenta ink 1 and Yellow ink 1 is 5 ng, the four colors can be printed at one location by one scanning using four individual heads for respective colors, and the time lag of between ejecting the black ink and ejecting the nearest color ink was 32 ms). Recording is carried out with a proportion of 100% of Black ink 1 and each 30% of Cyan ink 1, Magenta ink 1 and Yellow ink 1, with reciprocal movement of the head in two divisions, to thereby form a black image. The paper are FX-P Paper (manufactured by Fuji Xerox Co, Ltd.), and 4024 Paper and 4200 Paper (manufactured by Xerox Corporation).

The black images obtained in Example 1 and Comparative Examples 1 to 3 are assessed for the following characteristics. The results are shown in the Table 2.

(Density of Black Image)

The black images obtained in Example 1 and Comparative Examples 1 to 3 are measured for density using an optical densitometer X-Rite MODEL 404 (manufactured by X-Rite Inc.). The evaluations are carried out according to the following criteria.

◯ . . . Density of black image is 1.4 or more

Δ . . . Density of black image is 1.2 or more and less than 1.4

X . . . Density of black image is less than 1.2

(Evaluation of Dryness).

Black images are formed on paper as in Example 1 and Comparative Examples 1 to 3. The same kind of paper is stacked on the printed paper to contact with the formed image, and a time period to a point of time when transfer of the ink onto the back of the stacked paper no longer occurred is evaluated according to the following criteria.

◯ . . . 5 seconds or less

Δ . . . More than 5 seconds and less than 10 seconds

X . . . 10 seconds or more

(Test for Recovery from Clogging)

It is confirmed that proper recording can be performed using the above recording apparatus. The apparatus is left standing with a cap put on and left in an atmosphere of 23° C. and 55% RH. Recovering operation is carried out by spraying ink droplets and the number of spraying times until the properly recording can be resumed is rated according to the following criteria.

◯ . . . Recovered within 10,000 times

X . . . Not recovered even after 10,000 times

TABLE 2

| | Optical Density | | | Dryness of | | | Test for |
|---|---|---|---|---|---|---|---|
| | of Black Image | | | Black Image | | | Recovery |
| | | 4024 | 4200 | | 4024 | 4200 | from |
| | P Paper | Paper | Paper | P Paper | Paper | Paper | Clogging |
| Example 1 | ◯ | ◯ | ◯ | ◯ | ◯ | ◯ | ◯ |
| Comparative | Δ | ◯ | ◯ | Δ | X | ◯ | ◯ |
| Example 1 | | | | | | | |
| Comparative | Δ | Δ | X | ◯ | ◯ | ◯ | ◯ |
| Example 2 | | | | | | | |
| Comparative | Δ | ◯ | ◯ | ◯ | Δ | ◯ | ◯ |
| Example 3 | | | | | | | |

Table 2 shows that the results of Example 1, in which the ink set for inkjet recording according to the invention is used and the time lag between ejecting the black ink and ejecting the color ink is 16 ms, is superior in black image density, dryness and recovery from clogging.

As detailed above, the present invention can provide an ink set for inkjet recording that is capable of creating a black image having high density and a quick-drying time, a method and an apparatus for inkjet recording using the ink set.

What is claimed is:

1. An ink set for inkjet recording for forming a black image portion in a color image with a black ink and a color ink, wherein the black ink comprises at least cationic or anionic self-dispersible carbon black and the color ink comprises at least a substance having an opposite polarity to that of the self-dispersible carbon black.

2. The ink set for inkjet recording according to claim 1, wherein the self-dispersible carbon black is cationic and the color ink comprises at least an anionic substance.

3. The ink set for inkjet recording according to claim 1, wherein the carbon black is contained in an amount of 0.1 to 20% by mass relative to a total amount of the ink containing the black ink.

4. The ink set for inkjet recording according to claim 1, wherein the black ink and/or the color ink contain a surfactant, and the surfactant is present in an amount of 0.001 to 5% by mass relative to the amount of the black ink and the amount of the color ink, respectively.

5. The ink set for inkjet recording according to claim 1, wherein the black ink comprises a compound represented by formula (1):
R—O—XnH (1)
wherein R is a functional group having 4 to 8 carbon atoms selected from the group consisting of an alkyl group, an alkenyl group, an alkynyl group, a phenyl group, an alkylphenyl group, an alkenylphenyl group and a cycloalkyl group; X is an oxyethylene group or an oxypropylene group; and n is an integer from 1 to 4.

6. A method for inkjet recording comprising:
recording a color image in accordance with recording signals by ejecting from an orifice a black ink and a color ink, wherein the black ink comprises at least cationic or anionic self-dispersible carbon black and the color ink comprises at least a substance having an opposite polarity to that of the self-dispersible carbon black, and wherein a black image portion in the color image is formed with the black ink and the color ink, and a time lag between ejecting of the black ink and ejecting of the color ink is 20 ms or less.

7. The method for inkjet recording according to claim 6, wherein the self-dispersible carbon black is cationic and the color ink comprises at least an anionic substance.

8. The method for inkjet recording according to claim 6, wherein the order of ejecting the black ink and ejecting the color ink changes.

9. The method for inkjet recording according to claim 6, wherein the carbon black is contained in an amount of 0.1 to 20% by mass relative to a total amount of the ink containing the black ink.

10. The method for inkjet recording according to claim 6, wherein the black ink and/or the color ink contain a surfactant, and the surfactant is present in an amount of 0.001 to 5% by mass relative to the amount of the black ink and the amount of the color ink, respectively.

11. The method for inkjet recording according to claim 6, wherein the black ink comprises a compound represented by formula (1):
R—O—XnH (1)
wherein R is a functional group having 4 to 8 carbon atoms selected from the group consisting of an alkyl group, an alkenyl group, an alkynyl group, a phenyl group, an alkylphenyl group, an alkenylphenyl group and a cycloalkyl group; X is an oxyethylene group or an oxypropylene group; and n is an integer from 1 to 4.

12. An apparatus for inkjet recording for forming a color image comprising:
at least an ink cartridge for ejecting a black ink and another ink cartridge for ejecting a color ink, wherein the black ink comprises at least cationic or anionic self-dispersible carbon black and the color ink comprises at least a substance having an opposite polarity to that of the self-dispersible carbon black, and wherein a black image portion in the color image is formed with the black ink and the color ink, and a time lag between ejecting of the black ink and ejecting of the color ink is 20 ms or less.

13. The apparatus for inkjet recording according to claim 12, wherein the self-dispersible carbon black is cationic and the color ink comprises at least an anionic substance.

14. The apparatus for inkjet recording according to claim 12, wherein recording is carried out by reciprocal scanning of the ink cartridge for ejecting a black ink and the another ink cartridge for ejecting a color ink, and the order of ejecting the black ink and ejecting the color ink changes by the reciprocal scanning.

15. The apparatus for inkjet recording according to claim 12, wherein the carbon black is contained in an amount of 0.1 to 20% by mass relative to a total amount of the ink containing the black ink.

16. The apparatus for inkjet recording according to claim 12, wherein the black ink and/or the color ink contain a surfactant, and the surfactant is present in an amount of 0.001 to 5% by mass relative to the amount of the black ink and the amount of the color ink, respectively.

17. The apparatus for inkjet recording according to claim 12, wherein the black ink comprises a compound represented by formula (1):
R—O—XnH (1)
wherein R is a functional group having 4 to 8 carbon atoms selected from the group consisting of an alkyl group, an alkenyl group, an alkynyl group, a phenyl group, an alkylphenyl group, an alkenylphenyl group and a cycloalkyl group; X is an oxyethylene group or an oxypropylene group; and n is an integer from 1 to 4.
